(19) United States
(12) Patent Application Publication
(10) Pub. No.: US 2003/0215013 A1
(43) Pub. Date: Nov. 20, 2003

(54) Audio encoder with adaptive short window grouping

(76) Inventor: Dmitry N. Budnikov, N. Novgorod (RU)

Correspondence Address: TROP PRUNER & HU, PC, 8554 KATY FREEWAY, SUITE 100, HOUSTON, TX, 77024, US

(21) Appl. No.: 10/120,986

(22) Filed: Apr. 10, 2002

(51) Int. Cl. H04N 7/12; H04B 1/66

(52) U.S. Cl. 375/240.16; 375/240.01; 375/240.26

(57) ABSTRACT

An improved encoder of the type which generates long windows and short windows, and in which the short windows are grouped. The improvement lies in adaptively grouping the short windows, rather than in statically grouping them all together or all individually. In one embodiment, a new group is begun when a perceptual entropy value of a window crosses a predetermined threshold value with respect to its predecessor. In another embodiment, each group whose perceptual entropy value exceeds the threshold is its own group. The invention can be embodied as a digital audio encoder, for example.

### BACKGROUND OF THE INVENTION

1. Technical Field of the Invention

This invention relates generally to digital audio encoding, and more particularly to an improved audio encoder with adaptive grouping of short windows.

2. Background Art

A digital audio encoder creates a bitstream, typically including both auditory data and header data. It is desirable for the encoder to achieve high compression to reduce the transmission bandwidth and filesize of the bitstream output. It is also desirable that when a decoder plays the bitstream, the analog audio output faithfully reproduces the original with as little noise, corruption, distortion, and artifacting as possible.

Modern encoders rely upon psychoacoustic perceptual models to determine, for example, what aspects of the original audio data need not be represented in the output bitstream. In short, if the listener cannot hear something, there is no sense encoding it in the bitstream.

One audio characteristic which the human ear is especially sensitive to, and which is somewhat difficult to handle in conventional digital audio encoders, is the presence of sharp transients in the audio signal, such as occur often with percussion instruments such as drums and castanets, and with some other non-percussive “pitched signals” including some digitized speech. Due to the way that many encoders process and compress the audio signal, sharp transients often produce so-called “pre-echo distortion” in which the portion of the signal immediately preceding the transient becomes distorted due to the sudden and greater amplitude of the signal at the transient. Pre-echo occurs when there is a sharp transient near the end of a block, and the earlier part of the block includes a low-energy signal. In block-based algorithms, block average spectral estimation and time-frequency uncertainty cause the inverse transform function to spread quantization distortion even over the whole block. When there is a low-energy segment in the same block with a sharp transient near the end of the block, this quantization distortion can be of significant magnitude with respect to the low-energy segment's actual signal content. Other distortions may also occur, but pre-echo is a useful representative for them.

Some recent encoders, such as the MPEG 2, 4 Advanced Audio Coder (AAC), attempt to reduce pre-echo distortion and other problems caused by sharp transients and by performing quantization and encoding upon shorter sections of audio data when sharp transients are present, and longer sections in their absence.

FIG. 1 illustrates a high-level abstraction of an encoder 10 such as is known in the prior art. The encoder includes a filterbank analyzer 12 and a psychoacoustic perceptual model 14, both of which receive the audio input data, typically in the form of a .WAV or other pulse coding modulation (PCM) file. The psychoacoustic perceptual model determines, among other things, where transients are found and how they should be handled. The perceptual model determines the existence of transients, and decides whether to use short windows for time-to-frequency domain mapping. The filterbank analyzer uses this information to perform the time-to-frequency domain mapping. The filterbank analyzer outputs one set of spectral coefficients if the perceptual model indicated a long window, or multiple sets if the perceptual model indicated short windows. Both provide input to a quantization and encoding module 16, which performs the encoding of audio data from the filterbank analyzer in response to transient windowing controls from the psychoacoustic perceptual model. The quantization and encoding module quantizes and encodes spectral data according to a set of allowed noise threshold values provided by the perceptual model. A bitstream encoder 18 collects quantized spectral values, scale factors, and some additional information necessary for a decoder (not shown) to reconstruct the encoded data, and generates the output bitstream. Some encoders use entropy coding, such as Huffman coding, to further reduce the number of bits to be placed in the bitstream. The decoder can decode the bitstream and reproduce the original audio signal, within the limits imposed by the quality of the bitstream, of course.

FIG. 2 illustrates a high-level abstraction of portions of the psychoacoustic perceptual model 14 such as is suggested by the MPEG AAC encoder standard. The audio input data is received by a perceptual entropy detector 22, which provides input to a window length selector 24. If the current audio segment does not contain sufficiently sharp transients, the window length selector will indicate that a long window should be used to encode the audio segment. If the audio segment contains sufficiently sharp transients, the window length selector will indicate that short windows should be used. In the case of the MPEG AAC encoder, short windows exist in sets of eight consecutive short windows. A perceptual entropy threshold value 26 is used to determine what constitutes a sufficiently sharp transient to warrant using short windows.

FIG. 3 illustrates an audio signal having a sharp transient, as shown.

FIG. 4 illustrates the pre-echo distortion that results from encoding the audio signal of FIG. 3 with too long of a window. The longer the amount of audio signal (or time) that precedes the transient in the window, the longer will be the duration of the pre-echo distortion. An excellent analysis of the state of the prior art is found in “Perceptual Coding of Digital Audio”, by Ted Painter and Andreas Spanias, Dept. of Electrical Engineering, Telecommunications Research Center, Arizona State University.

What is needed is an improved audio encoder which gives advantages such as improved sound quality, such as one which has improved ability to encode audio which has sharp transients.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows an audio encoder according to the prior art.

FIG. 2 shows a psychoacoustic perceptual model according to prior art.

FIG. 3 shows an audio signal having a sharp transient, as is known in the prior art.

FIG. 4 shows pre-echo distortion resulting from encoding the audio signal of FIG. 3, as is known in the prior art.

FIG. 5 shows one embodiment of an audio encoder according to this invention.

FIG. 6 shows another embodiment of an audio encoder according to this invention.

FIGS. 7-10 show various groupings of short windows according to this invention.

FIG. 11 shows one embodiment of a method of operation of the invention.

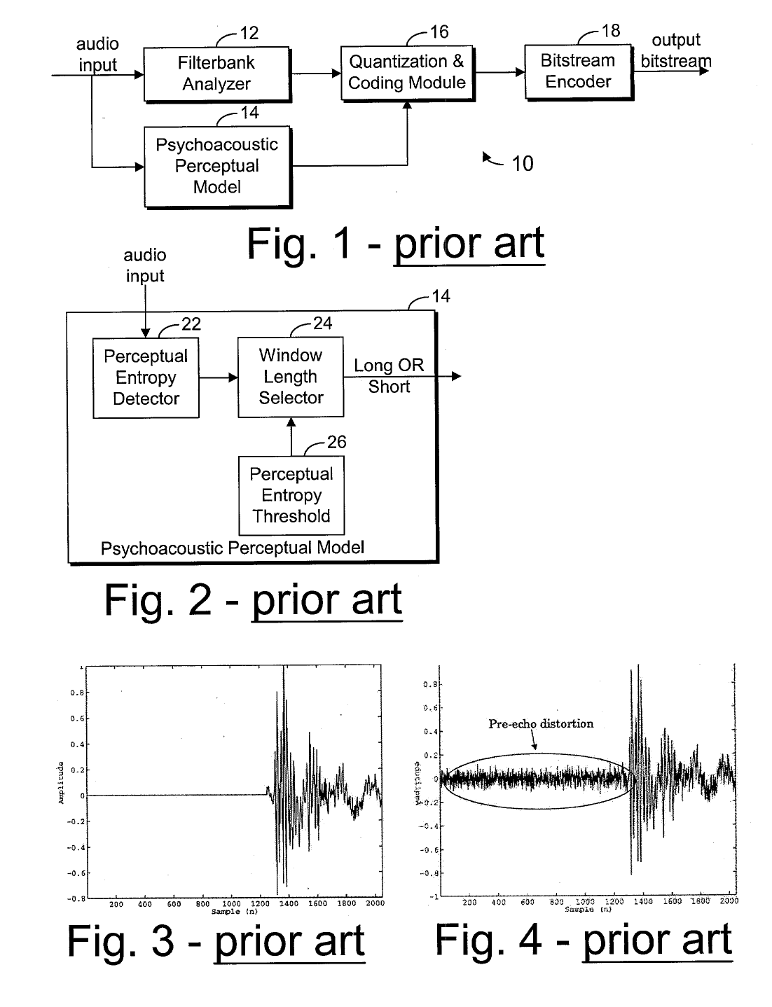

### DETAILED DESCRIPTION

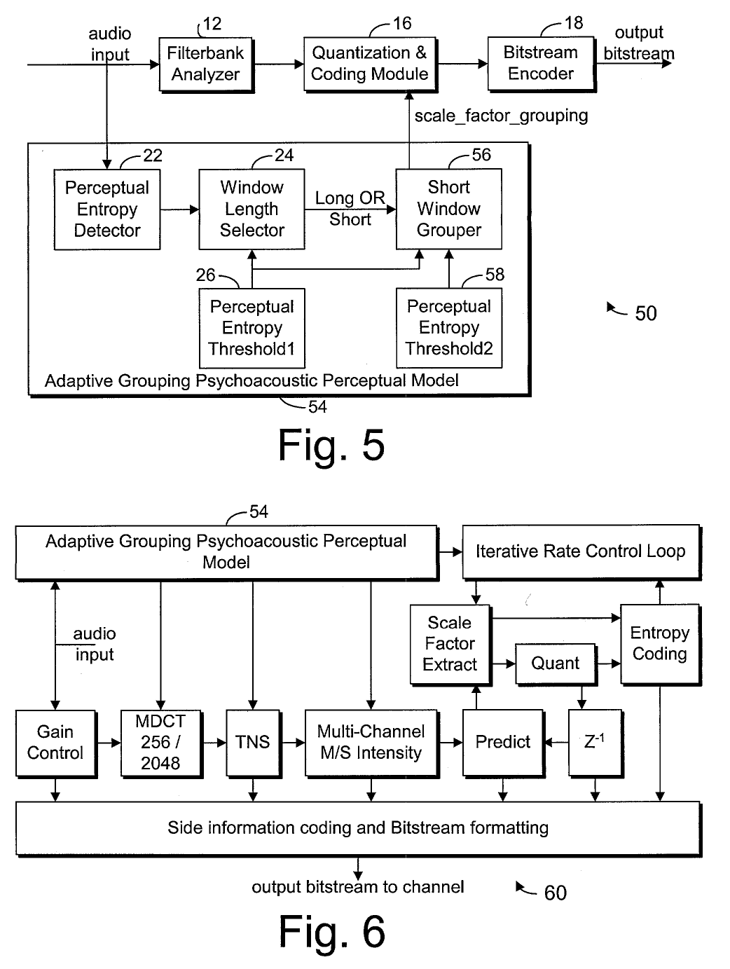

FIG. 5 illustrates one embodiment of an encoder 50 including this invention. The filterbank analyzer 12, quantization and coding module 16, and bitstream encoder 18 are not necessarily different than in the prior art. The perceptual model of the prior art is improved, and may be termed an adaptive grouping psychoacoustic perceptual model 54.

The adaptive grouping psychoacoustic perceptual model includes a perceptual entropy detector 22, and a window length selector 24, as before, for determining whether to use long windows or short windows. The window length selector operates according to a first perceptual entropy threshold value 26, as before. Once a determination has been made that short windows should be used, a short window grouper 56 determines the value of the parameter (scale_factor_grouping) which defines group boundaries of the short windows. In some embodiments, the short window grouper operates according to the first perceptual entropy threshold value 26. In other embodiments, it operates according to a second perceptual entropy threshold value 58. In still other embodiments, it may operate according to both, or according to still other values.

Perceptual entropy is but one example of a signal characteristic upon which grouping decisions can be based. The invention will be explained with reference to perceptual entropy, but is not limited to such. This skilled reader will appreciate how to utilize this invention in performing grouping based upon threshold determinations with respect to signal characteristics per the needs of the application at hand.

FIG. 6 illustrates another embodiment of an encoder 60 according to this invention, and is shown in an architectural format similar to that commonly used in illustrating the MPEG AAC encoder. The encoder includes an adaptive grouping psychoacoustic perceptual model 54 which may, in some embodiments, be constructed as shown in FIG. 5. The encoder further includes an iterative rate control loop, a gain control, a modified discrete transform (MDCT) block, a temporal noise shaping (TNS) block which decreases volume of noise induced during encoding by flattening the spectral envelope, a multi-channel mid/side stereo (M/S) intensity module which encodes two audio channels as sum and difference of signals in the channels and performs joint coding of the high frequency portions of both channels, a predictor (“Predict”), a Z⁻¹ block which takes into account information from the immediately previous encoded block of the signal to facilitate prediction, a scale factor extractor, a quantizer (“Quant”), an entropy encoding module, and a side information coding and bitstream formatting module, as shown.

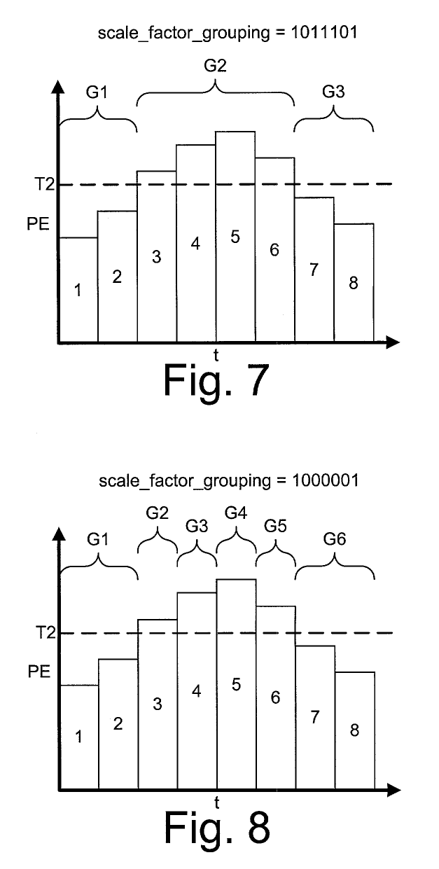

FIG. 7 illustrates one method of operation of the adaptive grouping psychoacoustic perceptual model of this invention. For each of the eight short windows, a perceptual entropy (PE) value is calculated, as represented by the bars labeled 1-8. When the PE value crosses (above or below) the predetermined threshold value (T2), a new window group is started. In the MPEG AAC embodiments, this can be indicated in the bitstream by giving a corresponding value to the seven-bit scale_factor_grouping parameter. Each bit position is a binary value indicating whether the corresponding window is the start of a new group of short windows. Although there are eight short windows, the parameter has only seven bits, because the first short window is always the start of a group; thus, the highest order bit position scale_factor_grouping[6] corresponds to short window 2, and the lowest order bit position scale_factor_grouping[0] corresponds to short window 8. The reader will appreciate, of course, that the numbering conventions, the parameter name and size, the number of short windows, and so forth can be changed without departing from the scope of this invention, and that the MPEG AAC example is given only for purposes of illustration. In one embodiment, a 0 indicates the start of a new group and a 1 indicates that the window belongs to the same group as the previous block. The parameter value 1011101 indicates that short windows 1 and 2 are a first group (G1), short windows 3 through 6 are a second group (G2), and short windows 7 and 8 are a third group (G3). A new group is started at short window 3 because the PE of short window 2 was below the threshold T2, but the PE of short window 3 was above the threshold T2. A new group is started at short window 7 because the PE of short window 6 was above the threshold T2, but the PE of short window 7 was below the threshold T2.

FIG. 8 illustrates another embodiment of a method of operation of the invention, in which a new group is started for each short window whose PE is above the threshold value T2, and at threshold crossings. Short windows 1 and 2 are a first group (G1). Short window 3 is a new group (G2) because its PE is above the threshold. Short windows 4, 5, and 6 each is a new group by itself, because its PE is still above the threshold. Short windows 7 and 8 are a sixth group (G6) because the PE of short window 6 was above the threshold, but the PE of short window 7 dropped below the threshold.

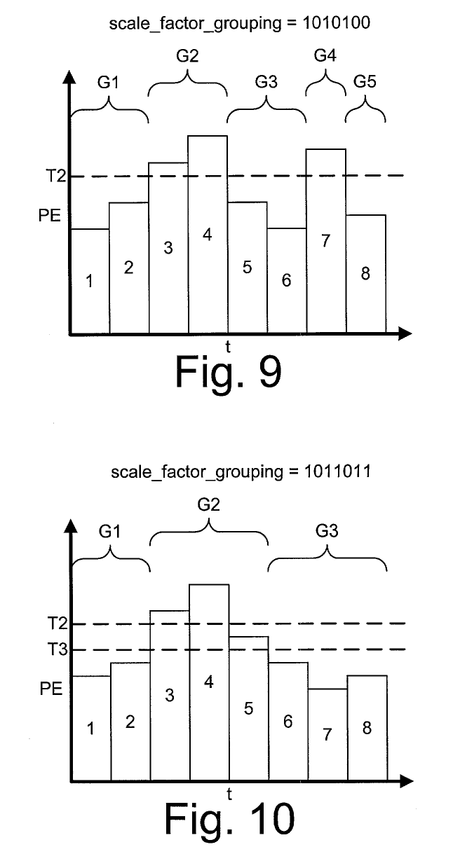

FIG. 9 illustrates another example using the same methodology as in FIG. 7, where new windows are started at threshold crossings.

FIG. 10 illustrates another embodiment in which a first threshold value T2 is used for upward crossings, and a second threshold value T3 is used for downward crossings. Short windows 1 and 2 are a first group (G1). Short window 3 starts a new group (G2) because its PE rose above T2. Short window 5 is also in G2 because, even though its PE has fallen below T2, it is still above T3. Short window 6 starts a new group (G3) because its PE has fallen below T3. In other embodiments, the T3 threshold may be above the T2 threshold.

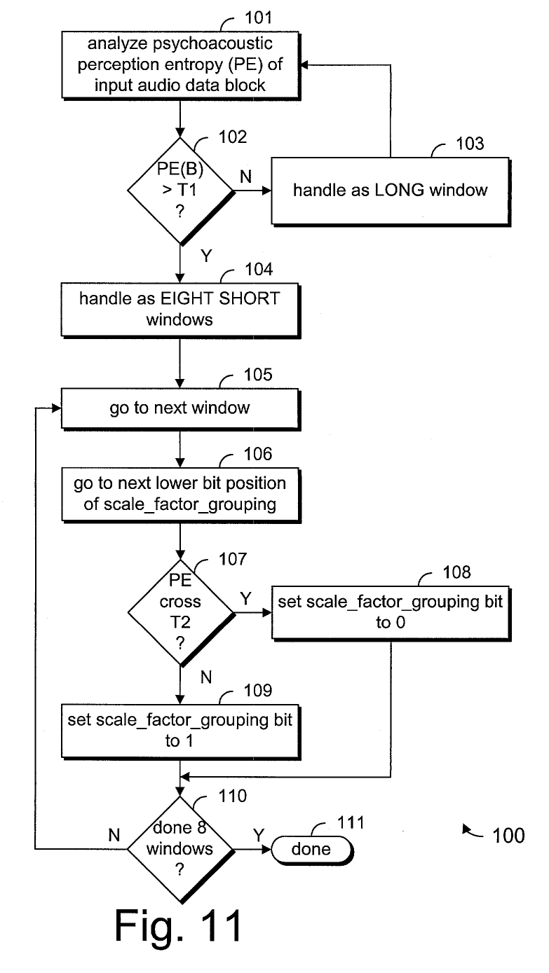

FIG. 11 illustrates one embodiment of a method 100 of operation of the adaptive grouping psychoacoustic perceptual model of this invention. The model analyzes (101) or calculates the psychoacoustic perceptual entropy (PE) of an input audio data block. If (102) the PE is not above a first threshold (T1), there is not too much entropy (meaning there are no sharp transients), and the block can be handled (103) as a LONG window. Otherwise, there are transients, and the block should be handled (104) as a EIGHT SHORT windows. The first window always starts a new block. Beginning with the next (105) window, the value of the next bit position (106) of the scale_factor_grouping parameter is determined. If (107) the PE of the window has crossed the threshold (T2) with respect to the PE of the prior window, the scale_factor_grouping bit is set to 0. Otherwise, it is set (109) to 1, indicating that the corresponding short window does not begin a new group. If (110) all eight windows are not analyzed, operation returns to analyze the next window (105). Otherwise, the method is done (111).

The reader will appreciate that this invention may be practiced in a wide variety of applications, not limited to MPEG AAC nor even limited to audio encoding, and that these have been used as examples for illustration only.

The reader will appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An method of generating an encoded bitstream, the method comprising:
(A) analyzing a signal characteristic of an input data block;
(B) in response to the analyzed signal characteristic, encoding the input data block as one of (i) a long window and (ii) a plurality of short windows;
(C) if the input data block is encoded as a plurality of short windows, for each short window after a first of the plurality of short windows,
if the signal characteristic in the short window crosses a predetermined threshold with respect to the signal characteristic in a preceding short window,
(a) including in the encoded bitstream a value indicating that the short window begins a new group, otherwise
(b) including in the encoded bitstream a value indicating that the short window does not begin a new group.

2. The method of claim 1 wherein the input data block comprises audio data and the method generates an encoded audio bitstream.

3. The method of claim 2 further comprising:
generating the bitstream to be compatible with the MPEG AAC standard.

4. The method of claim 3 wherein:
the value indicating that a respective short window does or does not begin a new group, comprises a respective bit position in a scale_factor_grouping parameter in the encoded bitstream.

5. The method of claim 1 wherein the predetermined threshold comprises:
a first threshold value for determining whether to start a new group when the signal characteristic in the short window is greater than the signal characteristic in the preceding short window; and
a second threshold value, different than the first threshold value, for determining whether to start a new group when the signal characteristic in the short window is less than the signal characteristic in the preceding short window.

6. The method of claim 1 wherein the (a) including comprises:
including in the encoded bitstream the value indicating that the short window begins a new group, for each short window having the signal characteristic greater than the predetermined threshold.

7. The method of claim 1 wherein the (a) including comprises:
including in the encoded bitstream the value indicating that the short window begins a new group, for each short window having the signal characteristic greater than the predetermined threshold and having a preceding short window whose signal characteristic was not greater than the predetermined threshold.

8. The method of claim 1 wherein the (a) including comprises:
including in the encoded bitstream the value indicating that the short window begins a new group, for each short window having the signal characteristic greater than the predetermined threshold and having a preceding short window whose signal characteristic was not greater than the predetermined threshold, and for each short window having the signal characteristic less than the predetermined threshold and having a preceding short window whose signal characteristic was greater than the predetermined threshold.

9. The method of claim 8 wherein the value indicating that the short window begins a new group comprises a binary 0.

10. The method of claim 1 wherein the signal characteristic comprises psychoacoustic perceptual entropy.

11. An apparatus for encoding a data stream to generate an encoded output bitstream, the apparatus comprising:
a quantization and coding module;
an adaptive grouping perceptual model including,
a perceptual entropy detector for determining a perceptual entropy level of a block from the data stream,
a window length selector for selecting a long window if the perceptual entropy level is above a predetermined threshold and for otherwise selecting a plurality of short windows,
a short window grouper, responsive to the window length selector having selected the plurality of short windows, to group the short windows in a number of groups that is greater than one and less than the number of short windows; and
a bitstream encoder responsive to the adaptive grouping perceptual model and the quantization and coding module to generate the encoded output bitstream and include in it a parameter identifying grouping of the short windows.

12. The apparatus of claim 11 wherein the encoded output bitstream comprises audio data and the adaptive grouping perceptual model comprises an adaptive grouping psychoacoustic perceptual model.

13. The apparatus of claim 12 wherein the apparatus is compliant with the MPEG AAC standard.

14. The apparatus of claim 13 wherein the parameter comprises the MPEG AAC standard's if scale_factor_grouping parameter.

15. The apparatus of claim 11 further comprising:
a filterbank analyzer coupled to the adaptive grouping perceptual model.

16. An audio encoder comprising:
a filterbank analyzer for receiving and performing time-to-frequency domain mapping upon audio input data;
a quantization and coding module coupled to the filterbank analyzer for quantizing and encoding spectral data from the audio input data;
an adaptive grouping psychoacoustic perceptual model for determining whether a block of the audio input data should be encoded as a long window or as a plurality of short windows, and for grouping the short windows according to respective perceptual entropy levels of each short window and its preceding short window;
a bitstream encoder coupled to the quantization and coding module and to the adaptive grouping psychoacoustic perceptual model for generating an encoded audio output bitstream and including in the encoded audio output bitstream a parameter indicating how the short windows are grouped.

17. The audio encoder of claim 16 wherein the adaptive grouping psychoacoustic perceptual model comprises:
a perceptual entropy detector;
storage for at least one perceptual entropy threshold value; and
a comparator for comparing a value output by the perceptual entropy detector against the perceptual entropy threshold value.

18. The audio encoder of claim 17 wherein the adaptive grouping psychoacoustic perceptual model further comprises:
a short window grouper for generating the parameter.

19. The audio encoder of claim 17 wherein the audio encoder is compatible with the MPEG AAC standard.

20. The audio encoder of claim 19 wherein the plurality of short windows comprises eight short windows and the adaptive grouping psychoacoustic perceptual model groups the short windows by generating a seven-bit parameter.

21. An MPEG AAC compatible audio encoder comprising:
an adaptive grouping psychoacoustic perceptual model for receiving audio input data and for grouping short windows in N groups where N>1 and N<8;
an iterative rate control loop responsive to the adaptive grouping psychoacoustic perceptual model;
a scale factor extraction module responsive to the iterative rate control loop;
a quantizer responsive to the scale factor extraction module;
an entropy coding module responsive to the scale factor extraction module and the quantizer; and coupled to the iterative rate control loop;
a previous-block analysis module responsive to the quantizer module;
a modified discrete cosine transform module responsive to the adaptive grouping psychoacoustic perceptual model;
a prediction module responsive to the previous-block analysis module and providing input to the scale factor extraction module; and
a side information coding and bitstream formatting module responsive to the prediction module, the previous-block analysis module, and the entropy coding module, for generating an MPEG AAC compatible encoded audio output bitstream.

22. The apparatus of claim 21 wherein the adaptive grouping psychoacoustic perceptual model comprises:
a perceptual entropy detector;
storage for at least one threshold value; and
a comparator for comparing the threshold value to a perceptual entropy value from the perceptual entropy detector.

23. The apparatus of claim 21 wherein the adaptive grouping psychoacoustic perceptual model further comprises:
means for generating a scale_factor_grouping parameter in response to a series of results from the comparator upon sequential pairs of short windows.

24. The apparatus of claim 21 further comprising:
a gain control module for receiving the audio input data;
a modified discrete cosine transform module responsive to the gain control module and the adaptive grouping psychoacoustic perceptual model;
a temporal noise shaping module responsive to the modified discrete cosine transform module and the adaptive grouping psychoacoustic perceptual model; and
a multi-channel mid/side stereo intensity module responsive to the temporal noise shaping module and the adaptive grouping psychoacoustic perceptual model.

25. The apparatus of claim 21 wherein:
N>=1 and N<=8.

26. An article of manufacture comprising:
a machine-accessible medium including data that, when accessed by a machine, cause the machine to perform the method of claim 1.

27. The article of manufacture of claim 26 wherein the machine-accessible medium further includes data that cause the machine to perform the method of claim 2.

28. The article of manufacture of claim 26 wherein the machine-accessible medium further includes data that cause the machine to perform the method of claim 5.

29. The article of manufacture of claim 26 wherein the machine-accessible medium further includes data that cause the machine to perform the method of claim 6.

30. The article of manufacture of claim 26 wherein the machine-accessible medium further includes data that cause the machine to perform the method of claim 7.

31. The article of manufacture of claim 26 wherein the machine-accessible medium further includes data that cause the machine to perform the method of claim 8.

32. An article of manufacture bearing software for generating an encoded bitstream representing audio input data, wherein the software comprises:
routines comprising a filterbank analyzer adapted to receive the audio input data and provide filterbank output;
routines comprising an adaptive grouping psychoacoustic perceptual model adapted to determine perceptual entropy values of the audio input data and, responsive to the perceptual entropy values, to indicate one of a long window and a plurality of short windows, and, if the plurality of short windows are indicated, to generate a grouping parameter having a value indicating how the plurality of short windows are to be grouped, wherein the value of the grouping parameter indicates at least two groups and at least one of the groups includes at least two short windows;
routines comprising a quantization and coding module adapted to quantize and code the filterbank output as long windows and short windows and to group the short windows in response to the grouping parameter; and
routines comprising a bitstream encoder adapted to generate the encoded bitstream in response to output from the quantization and encoding module.

33. The article of manufacture of claim 32 wherein the routines comprising the adaptive grouping psychoacoustic perceptual model are further adapted to generate the value of the grouping parameter by comparing the perceptual entropy value of a short window against a predetermined threshold value.

34. The article of manufacture of claim 33 wherein the routines comprising the adaptive grouping psychoacoustic perceptual model are further adapted to generate the value of the grouping parameter in response to whether the perceptual entropy value of the short window crosses the predetermined threshold with respect to a perceptual entropy value of a preceding short window.

35. The article of manufacture of claim 33 wherein the routines comprising the adaptive grouping psychoacoustic perceptual model are further adapted to generate the value of the grouping parameter in response to whether the perceptual entropy value of the short window is greater than the predetermined threshold.

36. The article of manufacture of claim 33 wherein the encoded bitstream is MPEG AAC compatible, short windows are in sets of eight, and the grouping parameter comprises seven bits, one for each of the second through eighth short windows.

37. The article of manufacture of claim 33 comprising a recordable medium.

38. The article of manufacture of claim 33 comprising a carrier wave.
